(19) United States
(12) Patent Application Publication
(10) Pub. No.: US 2008/0160294 A1
(43) Pub. Date: Jul. 3, 2008

(54) MULTIPLE LAYER GYPSUM CELLULOSE FIBER COMPOSITE BOARD AND THE METHOD FOR THE MANUFACTURE THEREOF

(75) Inventors: Mirza A. BAIG, Lindenhurst, IL (US); William O. WHITE, Darien, IL (US)

Correspondence Address: NOVAK DRUCE + QUIGG LLP;Anthony P. Venturino, 1300 Eye Street, NW, 1000 West Tower, WASHINGTON, DC, 20005, US

(73) Assignee: UNITED STATES GYPSUM COMPANY, Chicago, IL (US)

(21) Appl. No.: 11/616,454

(22) Filed: Dec. 27, 2006

(51) Int. Cl. B32B 13/08; B32B 3/18; B32B 13/02

(52) U.S. Cl. 428/332; 156/42; 428/537.7

(57) ABSTRACT

A gypsum cellulose fiber composite board having a cellulosic fiber layer on at least one surface layer of the composite material is disclosed. A continuous method for preparing the composite board is described wherein a cellulosic fiber first slurry is deposited on a traveling web from a head box to form a first cellulosic layer and a co-calcined gypsum and cellulosic fiber second slurry is deposited to form a co-calcined gypsum and cellulosic fiber second layer on the cellulosic first layer. If desired a cellulosic fiber third layer is deposited or coated on top of the co-calcined gypsum and cellulosic fiber second layer. A method including laminating a layer of wallboard paper to at least one surface of a co-calcined gypsum and cellulosic fiber composite panel is also disclosed.

### FIELD OF THE INVENTION

The invention relates to a new composite gypsum/cellulose fiber board having at least one paper layer on its surface that has the appearance of conventional wallboard. More particularly, the invention relates to a gypsum cellulose fiber composite board having a cellulosic fiber layer on at least one surface layer of the composite material with improved strength and rupture resistance at low densities and having the finished surface appearance of wallboard. The board is especially useful for making building products for interior use and has more strength than composite gypsum/cellulose fiber board. A continuous method for manufacturing one sided and two sided paper covered composite gypsum fiber board is also disclosed.

### BACKGROUND OF THE INVENTION

Certain properties of gypsum (calcium sulfate dihydrate) make it very popular for use in making industrial and building plasters and other building products; especially gypsum wallboard. It is a plentiful and generally inexpensive raw material which, through a method of dehydration and rehydration, can be cast, molded or otherwise formed to useful shapes. It is also noncombustible and relatively dimensionally stable when exposed to moisture. However, because it is a brittle, crystalline material which has relatively low tensile and flexural strength, its uses are typically limited to non-structural, non-load bearing and non-impact absorbing applications.

Gypsum wallboard, i.e. also known as plasterboard or drywall, has a rehydrated gypsum core sandwiched between multi-ply paper cover sheets, and is used largely for interior wall and ceiling applications. The paper cover sheets contribute significantly to the strength of plasterboard, but, in doing so, compromise its fire resistance. Furthermore, because of the brittleness and low nail and screw holding properties of its gypsum core, conventional drywall by itself cannot support heavy appended loads or absorb significant impact.

U.S. Pat. No. 5,320,677 of M. Baig, incorporated herein by reference in its entirety, discloses mixing uncalcined gypsum and host fiber particle with sufficient liquid to form dilute slurry which is then heated under pressure to calcine the gypsum, converting it to a calcium sulfate alpha hemihydrate. While not wanting to be limited to any theory, it is believed the dilute slurry menstruum wets out the host fiber particle, carrying dissolved calcium sulfate into the voids therein. The hemihydrate eventually nucleates and forms crystals, predominantly acicular crystals, and in-situ in and about the voids. Crystal modifiers can be added to the slurry if desired. The resulting composite is a host particle physically interlocked with calcium sulfate crystals. This interlocking not only creates a good bond between the calcium sulfate and stronger host particle, but prevents migration of the calcium sulfate away from the host particle when the hemihydrate is subsequently rehydrated to the dihydrate (gypsum).

The resulting material can be dried immediately before it cools to provide a stable, but rehydratable hemihydrate composite for later use. Alternatively, if it is to be directly converted into a usable product, the composite can be further separated from substantially all the liquid except that needed for rehydration, combined with other like composite particles into a desired shape, and then rehydrated to a set and stabilized gypsum composite mass.

A plurality of such composite particles form a material mass which can be compacted, pressed into boards, cast, sculpted, molded, or otherwise formed into desired shape prior to final set. After final set, the composite material can be cut, chiseled, sawed, drilled and otherwise machined. Moreover, it exhibits the desirable fire resistance and dimensional stability of the gypsum plus certain enhancements (particularly strength and toughness) contributed by the substance of the host particle.

Although the “co-calcined” gypsum and wood fiber board of Baig has proven to be successful for many building material uses, the surface of the GWF board appears unfinished since it does not have the paper layer of conventional wallboard preferred in interior uses.

### SUMMARY OF THE INVENTION

The present invention provides a method for producing a new gypsum cellulose fiber composite board product, which combines a co-calcined gypsum cellulose fiber board with the added strength and finished appearance of a one or two paper layers on the surface of the gypsum cellulose fiber board. The new board can be used in interior uses as well as for use where adhesive and coating applications as desired.

The invention is also directed to a new paper covered gypsum cellulose fiber composite board, such as gypsum wood fiber board (GWF), comprised of one or more layers of paper over a composite material which has uniformly good strength, including resistance to nail and screw pull-out, throughout its expanse; which is more dimensionally stable and maintains its strength even in a humid environment; which has high strength at less density than gypsum cellulose fiber board like GWF and which is faster to hydrate and therefore less costly to produce.

It has been found that the use of a paper layer on at least one side of the gypsum cellulose fiber board improves the board strength and modulus of rupture of the gypsum cellulose fiber board at lower density than standard gypsum cellulose fiber board.

It has also been found that the hydration and curing of the gypsum cellulose fiber board is unexpectedly accelerated by the use of the paper layer on at least one side of the composite board.

The paper and gypsum cellulose fiber board product of this invention will provide better cohesive bonds between the core and laminates in furniture applications and other thin laminate products.

In an embodiment the present method includes the steps of: co-calcining gypsum and fiber slurry; providing a layer of cellulose (including synthetic) fiber on a forming screen using fiber slurry through a head box and dewatering the first layer to provide a layer of fibers on the screen; continuing formation of a mat of desired thickness on top of the preformed fiber layer using the co-calcined composite slurry using a second head box and continuing the vacuum process; and then applying a third fiber layer by providing another layer of cellulose (including synthetic) fiber on the upper surface of the composite slurry on the forming screen. An overlay, flow coat or a third head box can be used to apply the third layer. The method also removes dewaters the layers after they are deposited while the temperature of the composite product slurry is still high.

### BRIEF DESCRIPTION OF DRAWINGS

FIG. 1 is a diagram of a method for forming a composite material with a layer of paper according to one aspect of the invention.

FIG.2 is a schematic diagram of a composite board in accordance with the invention with layers of paper on both surfaces of the composite core.

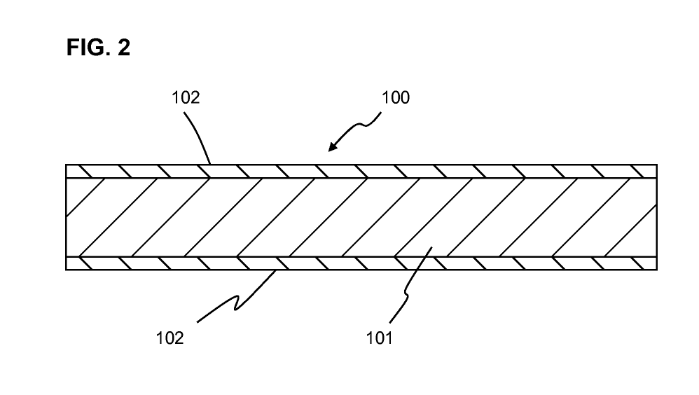

FIG. 3 is a diagram of another embodiment of the method of the invention for forming a composite board with layers of cellulosic fiber such as paper, laminated on one or more of the composite surfaces.

### DETAILED DESCRIPTION OF THE PREFERRED EMBODIMENTS

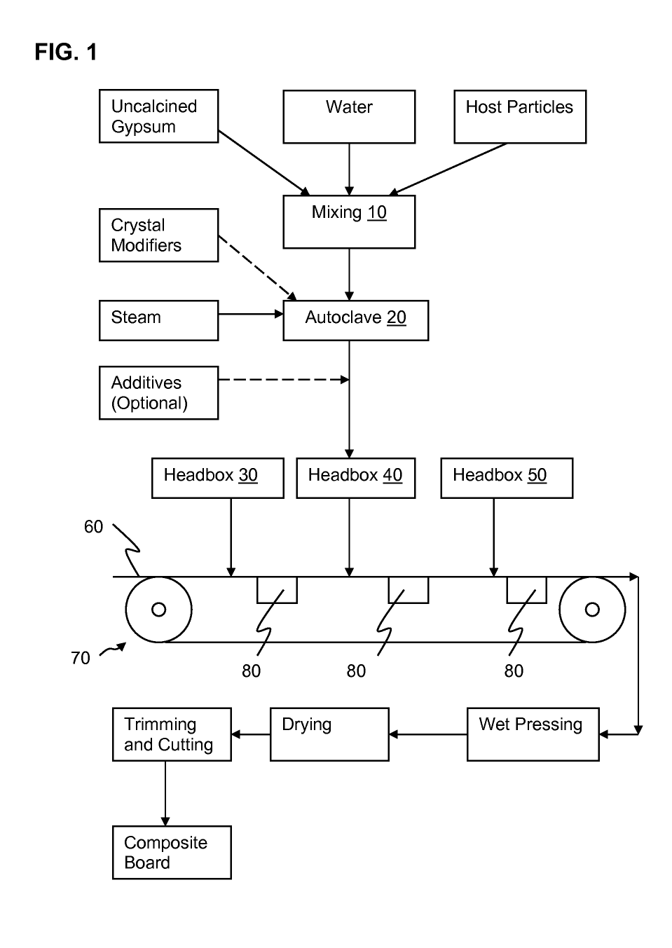

The basic method of forming the unique paper layer gypsum cellulose fiber board of this invention, as seen in the diagram method in FIG. 1 is to prepare a co-calcined gypsum and cellulose fiber from non-calcined gypsum, water and fiber autoclaved at temperatures above 200° C. under steam pressure to produce the co-calcined structure disclosed in U.S. Pat. No. 5,320,677 incorporated herein by reference in its entirety.

The next step is to provide a layer of cellulose fiber on a forming screen by depositing a fiber slurry containing from about 2 to about 5 % by weight cellulose fiber through a conventional head box slurry supply means to provide a paper slurry layer of about 0.25 to 0.50 inches and then dewatering the layer to provide a layer of fiber on the screen. The fiber layer is then moved through a second head box in which the gypsum wood fiber slurry is deposited upon the top of the fiber layer to under vacuum pressure from the autoclave. The gypsum cellulose fiber composite slurry is deposited until the desire thickness of about one inch is obtained. A third top layer of fiber is then applied as in the initial fiber slurry through a third head box or an alternative overlay or coating process. The multilayer paper and gypsum wood fiber composite panel is then pressed to the desired thickness, typically about 1.27 cm (0.5 inch), and density to remove up to 90% of the uncombined heated water before being cooled to a rehydration temperature of about 49° C. (120° F.). The pressed paper covered board is then rehydrated, dried and trimmed and cut.

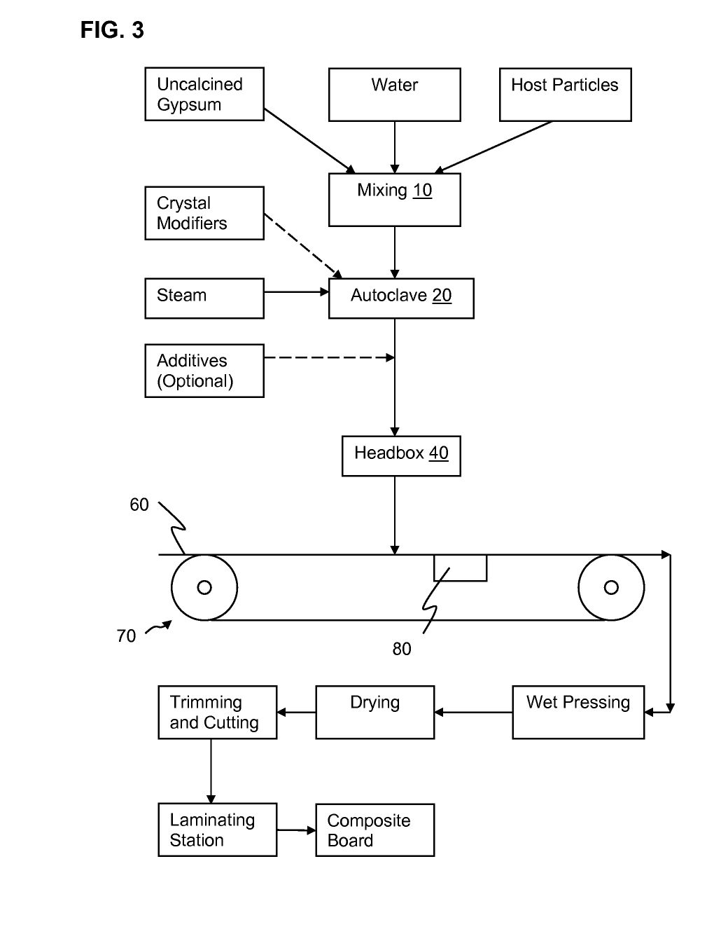

As seen in FIG. 3, the paper layer(s) 102 on the surface of the rehydrated and dried and cut composite core 101 of the finished board 100 is usually about 9-11 mm, which is typical of paper layer in conventional wallboard, but it can be varied from about 9-15 mm. The density of the final board can be varied depending upon the final intended use. Densities of about 270.3 kg./m³ (17 lbs/ft³), are typically used for ceiling panel while densities of up to 0.456.7-1112. kg m³ (30-70 lbs/ft³) are used for panels that are used for examples in flooring roofing, backerboard for ceramic tile, and walls. In each case, it has been found that strength can be obtained with lower densities panels composite gypsum cellulose board that has a surface layer of paper is used versus the core composite board. This has been found both with the continuous method of deposited the fiber from a continuous web or when a more time consuming method of laminating a wall paper is applied to one or both surfaces of the composite through use of an adhesive.

### Calcium Sulfate Hemihydrate

Calcium sulfate hemihydrate, which may be used in panels of the invention, is made from gypsum ore, or “gypsum” as used herein, a naturally occurring mineral, (calcium sulfate dihydrate CaSO₄.2H₂O). Unless otherwise indicated, “gypsum” will refer to the dihydrate form of calcium sulfate. After being mined, the raw gypsum is thermally processed to form a settable calcium sulfate, which may be anhydrous, but more typically is the hemihydrate, CaSO₄.1/2H₂O. For the familiar end uses, the settable calcium sulfate reacts with water to solidify by forming the dihydrate (gypsum). The hemihydrate has two recognized morphologies, termed alpha hemihydrate and beta hemihydrate. These are selected for various applications based on their physical properties and cost. Both forms react with water to form the dihydrate of calcium sulfate. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention either or both of the alpha or beta forms may be used depending on the mechanical performance desired. The beta hemihydrate forms less dense microstructures and is preferred for low density products. The alpha hemihydrate forms more dense microstructures having higher strength and density than those formed by the beta hemihydrate. Thus, the alpha hemihydrate could be substituted for beta hemihydrate to increase strength and density or they could be combined to adjust the properties.

A typical embodiment for the inorganic binder used to make panels of the present invention comprises a blend containing calcium sulfate alpha hemihydrate and host particle which is typically wood fiber, paper fiber such waste paper fiber, or wood chips.

### “Host Particle”

The term “host particle” is meant to cover any macroscopic particle, such as a fiber, a chip or a flake, of a substance other than gypsum, for use in the present invention. The particle, which is generally insoluble in the slurry liquid, should also have accessible voids therein; whether pits, cracks, fissures, hollow cores, or other surface imperfections, which are penetrable by the slurry menstruum and within which calcium sulfate crystals can form. It is also desirable that such voids are present over an appreciable portion of the particle; it being apparent that the more and better distributed the voids, the greater and more geometrically stable will be the physical bonding between the gypsum and host particle.

The substance of the host particle should have desirable properties lacking in the gypsum, and, preferably, at least higher tensile and flexural strength. A lignocelluloses fiber, particularly a wood fiber, is an example of a host particle especially well suited for the composite material and method of the invention. Therefore, without intending to limit the material and/or particles that qualify as a “host particle”, wood fiber(s) is often used hereafter for convenience in place of the broader term.

The host particle is preferably a cellulosic fiber which may come from waste paper, wood pulp, wood flakes, and/or another plant fiber source. It is preferable that the fiber be one that is porous, hollow, split and/or rough surfaced such that its physical geometry provides accessible interstices or voids which accommodate the penetration of dissolved calcium sulfate. In any event the source, for example, wood pulp, may also require prior processing to break up clumps, separate oversized and undersized material, and, in some cases, pre-extract strength retarding materials and/or contaminants that could adversely affect the calcination of the gypsum; such as hemi-celluloses, acetic acid, etc.

### Gypsum/Wood Fiber

The term gypsum wood fiber or GWF, as used herein is meant to cover mixtures of gypsum and host particles, e.g., wood fibers, used to produce boards wherein at least a portion of the gypsum is in the form of acicular calcium sulfate dihydrate crystals positioned in the voids of the host particles, wherein the dihydrate crystals are formed in situ by the hydration of acicular calcium sulfate hemihydrate crystals in and about the voids of said particles. The GWF boards are typically produced by the process of U.S. Pat. No. 5,320,677.

### Making the Board

A method for making the composite wallboard of the present invention is illustrated in the diagram of FIG. 1.

The process begins by mixing uncalcined gypsum and host particles (e.g. wood or paper fibers) with water to form dilute aqueous slurry. The source of the gypsum may be from raw ore or from the by-product of a flue-gas-desulphurization or phosphoric-acid process. The gypsum typically should be of a purity, i.e., 82-98%, and typically finely ground, for example, to 92-96%-minus 100 mesh or smaller. Larger particles may lengthen the conversion time. The gypsum can be introduced either as a dry powder or via aqueous slurry.

The invention co-calcines gypsum and fiber slurry by any suitable process. A typical process for making such composite slurry is disclosed by U.S. Pat. No. 5,320,677, incorporated herein by reference in its entirety. The present process also provides a first layer of cellulose (including synthetic) fiber on a forming web screen 60 on dewatering conveyor 70 using fiber slurry through a first head box 30 and dewaters it using a vacuum station 80 to provide a layer of fibers on the screen.

The process continues the mat formation to a desired thickness on top of the preformed fiber layer using the co-calcined composite slurry using a secondary head box 40 and continues the dewatering with the vacuum station 80.

Then the process applies a third fiber layer by providing another layer of cellulose (including synthetic) fiber on the upper surface of the composite slurry on the forming screen 60 through head box 50. An overlay, flow coat or a third head box 50 can be used to apply the third layer. After three layer mat formation, the dewatered composite mat can be pressed to desired thickness and density.

### Making the Composite Slurry

As shown in FIG. 1, to make composite slurry the input materials include uncalcined gypsum particles, host particles, such as refined cellulose fiber, preferably paper fiber or wood fiber, and water. The present process mixes between about 0.5% to about 30%, and preferably between about 3% to 20% or 10% to 20%, by weight (based on the total solids), wood fibers with the respective complement of ground, but uncalcined, gypsum. Typically the gypsum and cellulose fibers are mixed in respective proportions of about 5 to 1. The dry mix is combined with enough liquid, preferably water, to form a dilute slurry having about 70%-95% by weight water. The ground gypsum and wood fibers are mixed with sufficient water to make a slurry containing about 5-30% by weight solids, preferably about 5-20% by weight solids. The solids in the slurry should comprise from about 0.5% to 30% by weight of wood fibers and preferably from about 3% to 20% wood fibers, the balance being mainly gypsum. Typically the slurry has about 5-10% by weight solids.

After mixing in mixing station 10, the slurry is fed into a pressure vessel, such as a steam autoclave 20, equipped with a continuous stirring or mixing device. Crystal modifiers, such as organic acids, can be added to the slurry at this point, if desired, to stimulate or retard crystallization or to lower the calcining temperature. Steam is injected into the pressure vessel to bring the interior temperature of the pressure vessel to between about 100° C. (212° F.) and about 177° C. (350° F.), and autogeneous pressure. The lower temperature is approximately the practical minimum at which the calcium sulfate dehydrate will calcine to the hemihydrate state within a reasonable time; and the higher temperature is about the maximum temperature for calcining hemihydrate without undue risk of causing some the calcium sulfate hemihydrate to convert to anhydrite. Preferably, the slurry is processed in the pressure vessel at a temperature between about 140° C. to 152° C. (285° F. and 305° F.), and autogeneous pressure, for sufficient time to convert all the gypsum to fibrous calcium sulfate alpha hemihydrate. The slurry is preferably continuously mixed or stirred to break up clumps of fibers and to keep the materials in suspension as the conversion occurs.

When the slurry is processed under these conditions for a sufficient period of time, for example on the order of 15 minutes, enough water will be driven out of the calcium sulfate dihydrate molecule to convert it to the hemihydrate molecule. The-micro-mechanics of the invention are not fully understood. However, it is believed the solution, aided by the continuous agitation to keep the particles in suspension, will wet out and penetrate the open voids in the host fibers. In particular, the dilute slurry menstruum wets out the host particle, carrying dissolved calcium sulfate into the voids therein. As saturation of the solution is reached, the hemihydrate will nucleate and begin forming crystals in, on and around the voids and along the walls of the host fibers.

Thus, the hemihydrate eventually nucleates and forms crystals, predominantly acicular crystals, in-situ in and about the voids of the host particle. Crystal modifiers can be added to the slurry if desired. The resulting composite is a host particle physically interlocked with calcium sulfate crystals. This interlocking not only creates a good bond between the calcium sulfate and stronger host particle, but prevents migration of the calcium sulfate away from the host particle when the hemihydrate is subsequently rehydrated to the dihydrate (gypsum).

### Depositing and Dewatering the Layers

As mentioned above, a first layer of cellulose (including synthetic) fibers is applied on the flat porous forming surface of a forming web screen 60 on dewatering conveyor 70 using cellulose fiber slurry deposited on the web 60 through the first head box 30 and dewatered to provide a layer of fibers on the screen by the vacuum station 80. The dewatering conveyor 70 is typically a continuous felting dewatering conveyor, such as the type used in paper making operations. The slurry to form the first layer is typically discharged onto the continuous felting dewatering conveyor 70 and dewatered to remove as much uncombined water as possible.

When the conversion of the composite product slurry is complete, the pressure of the steam autoclave 20 is reduced, desired additives are introduced and the composite product slurry is discharged through a second head box 40 onto the first layer of cellulose (including synthetic) fibers already on the web 60 on the dewatering conveyor 70 to produce a filter cake. If desired, wax emulsion is added to the slurry, along with selected process modifying or property enhancing additives, such as accelerators, retarders, weight reducing fillers, etc. before the slurry is passed through the second head box 40 onto the web 60 on conveyor 70 on which a filter cake is formed. Conventional additives including accelerators, retarders, preservatives, fire retardants and strength enhancing agents may be added to the slurry at this point in the process. It has been found that certain additives, such as the particular accelerator (to speed the hydration of the calcium sulfate hemihydrate to gypsum) may markedly affect the level of improvement in water resistance achieved by the wax emulsion. As a result, potash is preferred as the accelerator over alum and other materials.

Then the process applies a third fiber layer by providing another layer of cellulose (including synthetic) fiber on the upper surface of the composite slurry on the forming screen 60. An overlay, flow coat or a third head box 50 can be used to apply the third layer. While, and after the layers are deposited, as much water is removed as possible while the temperature of the composite product slurry is still high.

Dewatering is ongoing as the three layers are being deposited and conveyed. The filter cake is dewatered by the evaporation of water when the slurry is released from the autoclave and by the water in the slurry passing through the porous forming surface and the paper layers, preferably aided by vacuum through vacuum stations 80. Although the dewatering causes cooling of the filter cake, additional external cooling may be applied during the dewatering step. As much of the water is removed as possible while the temperature of the product slurry is still relatively high and before the hemihydrate is substantially converted into gypsum. As much as 90% of the slurry water is removed in the dewatering device, leaving a filter cake of the deposited three layers of typically about 35% water by weight.

### Pressing and Rehydration

Following three layer mat formation and dewatering, and before its temperature falls below the rehydration temperature such that extensive rehydration takes place, the dewatered composite mat can be wet pressed for a few minutes to further reduce the water content and to achieve the desired end product thickness and/or density. If the board is to be given a special surface texture or a laminated surface finish, it would preferably occur during this step of the process.

Two things happen during the wet pressing, which preferably takes place with gradually increasing pressure to preserve the product's integrity. Additional water, for example about 50-60% of the remaining water, is removed. As a consequence of the additional water removal, the filter cake is further cooled to a temperature at which rapid rehydration occurs. The calcium sulfate hemihydrate hydrates to gypsum, so that the acicular calcium sulfate hemihydrate crystals are converted to gypsum crystals in situ in and around the wood fibers.

After some rehydration, the boards can be trimmed and cut, if desired, and then, after complete rehydration, sent through a kiln for drying. Preferably, the drying temperature should be kept low enough to avoid recalcining any gypsum on the surface. In the alternative the boards can be trimmed and cut after drying, as shown in FIG. 1.

Although the extraction of the bulk of the water in the dewatering step will contribute significantly to lowering the filter cake temperature, additional external cooling may be required to reach the desired rehydration temperature within a reasonable time. As a consequence of the water removal, the filter cake is cooled to a temperature at which rehydration may begin. However, it may still be necessary to provide additional external cooling to bring the temperature low enough to accomplish the rehydration within an acceptable time.

Aided by external cooling if necessary, the temperature of the composite layer is reduced to below about 49° C. (120° F/) so rehydration can take place.

Depending on the accelerators, retarders, crystal modifiers, or other additives provided in the slurry, hydration may take from only a few minutes to an hour or more.

The rate of rehydration and curing of the pressed composite board is also dependent upon the time it takes to press the heated water from the composite board and cool the composite down to the temperature when hydration can be initiated. In the case of composite board that does not have a paper surface layer, it is difficult to lower the composite mat temperature because of the high mat density, without the use of accelerators like heat resistant accelerators such as finely ground dihydrate gypsum, aluminum sulfate or potassium sulfate, to start the gypsum setting process. It has been found that in the method of this invention when cold or lower temperature fiber slurry layer is deposited on the hot, as much as 135° C. (275° F.), composite mat before pressing, the fiber layer will cool the mat during the pressing and thereby accelerate the hydration and setting process while maintaining the strength after the mat is dried into the final composite board.

The rehydration recrystallizes the gypsum in place, physically interlocked with the wood fibers. Because of the interlocking of the acicular hemihydrate crystals with the wood-fibers, and the removal of most of the carrier liquid from the filter cake, migration of the calcium sulfate is averted, leaving a homogeneous composite. The rehydration effects recrystallization of the hemihydrate crystals to dihydrate crystals in situ, i.e. within and about the voids of the wood fibers, thereby preserving the homogeneity of the composite. The crystal growth also connects the calcium sulfate crystals on adjacent fibers to form an overall crystalline mass, enhanced in strength by the reinforcement of the wood fibers.

When the hydration is complete, it is desirable to promptly dry the composite mass to remove the remaining free water. Otherwise, the hygroscopic wood fibers tend to hold, or even absorb, uncombined water which will later evaporate. If the calcium sulfate coating is fully set before the extra water is driven off, the fibers may shrink and pull away from the gypsum when the uncombined water does evaporate. Therefore, for optimum results it is preferable to remove as much excess free water from the composite mass as possible before the temperature drops below the level at which hydration begins.

### Drying

The pressed board, which typically contains about 30% by weight of free water, is then promptly dried at a relatively high temperature to reduce the free water content to about 0.5% or less in the final product. During the drying step it is important to raise the internal temperature of the final product high enough, for a short period of time, to thoroughly melt the wax (if present). Also, drying conditions which tend to calcine the gypsum should be avoided.

Thus, the pressed board is typically dried at a temperature between about 43° C. (110° F.) and 52° C. (125° F.); preferably about 49° C. (120°F.).

It is also desirable to carry out the drying under conditions in which the product achieves a core temperature of at least 77° C. (170° F.), and preferably a core temperature between about 77° C. (170° F.) and 93° C. (200° F.). In the laboratory trials, the drying of the board is carried out at a temperature of 78° C. (250° F.) for 15 minutes and then the board is stored overnight at a temperature of 43° C. (110° F.). This avoids calcining of the gypsum cellulose fiber in the board.

The set and dried board can be cut and otherwise finished to form a composite board of the desired specification.

When finally set, the unique composite material exhibits desired properties contributed by both of its two components. The wood fibers increase the strength, particularly flexural strength, of the gypsum matrix, while the gypsum acts as a coating and binder to protect the wood fiber, impart fire resistant and decrease expansion due to moisture.

A composite gypsum/cellulose-fiber board made according to the foregoing method offers a combination of desirable features and properties not afforded by conventional board products. It offers improved strength, including nail and screw pull-out resistance, over conventional plasterboard. It offers greater fire-resistance and better dimensional stability in a humid environment than lumber, fiberboard, particleboard, pressed paperboard and the like.

### Alternate Embodiment of a Method for Preparing the Board

The method, as seen in the diagramed method in FIG. 3, differs from the method diagrammed in FIG. 1 because the embodiment of FIG. 3, the fiber layer(s) are laminated on the surface of the composite after the gypsum cellulose fiber composite is already formed. The product slurry from autoclave 20 is deposited on the web 60 on the conveyor 70 through head box 40 and dewatered through vacuum station 80. The wet filter cake is then wet pressed, dried, trimmed and cut to form the gypsum cellulose fiber composite before one or more layers of fiber such as paper are laminated to the surfaces of the composite through use of conventional adhesives in a laminating station to form the composite board.

The method begins with a mixing of uncalcined gypsum, host particles (cellulose fibers e.g. wood fibers) and water to form dilute aqueous slurry. The source of the gypsum may be from raw ore or from the by-product of a flue-gas-desulphurization or phosphoric-acid method. The gypsum should be of a relatively high purity, i.e., preferably at least about 92-96%, and finely ground, for example, to 92-96% minus 100 mesh or smaller. Larger particles may lengthen the conversion time. The gypsum can be introduced either as a dry powder or as part of aqueous slurry.

The source of the cellulosic fiber may be waste paper, wood pulp, wood flakes, and/or another plant fiber source. It is preferable that the fiber be one that is porous, hollow, split and/or rough surfaced such that its physical geometry provides accessible interstices or voids which accommodate the penetration of dissolved calcium sulfate. In any event the source, for example, wood pulp, may also require prior processing to break up clumps, separate oversized and undersized material, and, in some cases, pre-extract strength retarding materials and/or contaminants that could adversely affect the calcinations of the gypsum; such as hemi-celluloses, acetic acid, etc.

The ground gypsum and cellulose fibers are mixed together in mixing station 10 in a ratio of about 0.5 to 30% by weight cellulose fibers. Sufficient water is added to make slurry having a consistency of about 5-30% by weight solids although, so far, 5-10% by weight solids has been preferable for efficient processing and handling on available laboratory equipment.

The slurry is fed into the pressure vessel 20 equipped with a continuous stirring or mixing device. Crystal modifiers, such as for example organic acids, can be added to the slurry at this point, if desired, to stimulate or retard crystallization or to lower the calcining temperature. After the vessel is closed, steam is injected into the vessel to bring the interior temperature of the vessel up to between about 100° C. (212° F.) and about 177° C. (350° F.), and autogeneous pressure; the lower temperature being approximately the practical minimum at which the calcium sulfate dihydrate will calcine to the hemihydrate state within a reasonable time; and the higher temperature being about the maximum temperature for calcining hemihydrate without undue risk of causing some the calcium sulfate hemihydrate to convert to anhydrite. Based on work done to date, the autoclave temperature is preferably on the order of about 140° C. (285° F.) to 152° C. (305° F.).

When the slurry is processed under these conditions for a sufficient period of time, for example on the order of 15 minutes, enough water will be driven out of the calcium sulfate dihydrate molecule to convert it to the hemihydrate molecule. The solution, aided by the continuous agitation to keep the particles in suspension, will wet out and penetrate the open voids in the host fibers. As saturation of the solution is reached, the hemihydrate will nucleate and begin forming crystals in, on and around the voids and along the walls of the host fibers.

After the conversion of the dihydrate to the hemihydrate is complete, the pressure on it is relieved when and as the slurry is discharged through the head box 40 onto a forming web screen 60 on dewatering conveyor 70.

Optional additives can be introduced into the slurry before the second paper layer is applied to the gypsum cellulose fiber slurry. As much as 90% of the slurry water is removed in the dewatering device, leaving a filter cake of approximately 35% water by weight. At this stage the filter cake comprises wood fibers interlocked with rehydratable calcium sulfate hemihydrate crystals and can still be broken up into individual composite fibers or nodules, shaped, cast, or compacted to a higher density. If it is desired to preserve the composite material in this rehydratable state for future use, it is necessary to dry it promptly, preferably at about 200° F. (93° C.), to remove the remaining free water before hydration starts to take place.

The dewatered filter cake can be directly formed into a desired product shape and then rehydrated to a solidified mass of composite calcium sulfate dihydrate and wood fibers. To accomplish this, the temperature of the formed filter cake is brought down to below about 49° C. (120° F.). Although, the extraction of the bulk of the water in the dewatering step will contribute significantly to lowering the filter cake temperature, additional external cooling may be required to reach the desired level within a reasonable time.

Depending on the accelerators, retarders, crystal modifiers, or other additives provided in the slurry, hydration may take from only a few minutes to an hour or more. Because of the interlocking of the acicular hemihydrate crystals with the wood-fibers, and the removal of most of the carrier liquid from the filter cake, migration of the calcium sulfate is averted, leaving a homogeneous composite. The rehydration effects a recrystallization of the hemihydrate to dihydrate in place within and about the voids and on and about the wood fibers, thereby preserving the homogeneity of the composite. The crystal growth also connects the calcium sulfate crystals on adjacent fibers to form an overall crystalline mass, enhanced in strength by the reinforcement of the cellulose fibers.

After wet pressing, and before the hydration is complete, it is desirable to promptly dry the composite mass to remove the remaining free water. Otherwise the hygroscopic wood fibers tend to hold, or even absorb, uncombined water which will later evaporate. If the calcium sulfate coating is fully set before the extra water is driven off, the fibers may shrink and pull away from the gypsum when the uncombined water does evaporate. Therefore, for optimum results it is preferable to remove as much excess free water from the composite mass as possible before the temperature drops below the level at which hydration begins.

Then the dried filter cake is trimmed and cut to form the gypsum cellulose fiber composite before one or more layers of fiber such as paper are laminated to the surfaces of the composite through use of conventional adhesives in a laminating station to form the composite board.

The unique composite material exhibits desired properties contributed by both of its two components. The wood fibers increase the strength, particularly flexural strength, of the gypsum matrix, while the gypsum acts as a coating and binder to protect the wood fiber, impart fire resistant and decrease expansion due to moisture.

In the event it is desired to impart a special surface finish to the board, the foregoing method can accommodate modification to affect the additional step. For example, it is foreseeable that additional dry ground dihydrate could be added to the product slurry discharged from the autoclave, sprayed over the hot slurry as it is distributed over the dewatering conveyor, or in the case when a second top layer of fiber is not used, sprinkled on the formed filter cake before it has been fully dewatered, to provide a smoother, lighter colored, and/or gypsum rich surface on the final board. A particular surface texture can be imparted to the filter cake in the wet pressing operation to provide a board with a textured finish. A surface laminate or coating would probably be applied after the wet pressing step and possibly after the final drying. At any rate, many additional variations on this aspect of the method will occur readily to those skilled in the art.

### EXAMPLE 1

Four samples of composite material as Test 1 and Test 2 set forth in TABLE 1 were made in two different runs with the three layer paper-composite-paper boards being made on a laboratory scale by forming a paper layer and dewatering the layer, depositing a gypsum wood fiber (GWF) slurry made by the process of U.S. Pat. No. 5,320,677 (used as the control) on the paper followed by dewatering and then depositing a face paper slurry on the GWF and dewatering pressing and drying. The composite was prepared using a slurry comprising 90 wt % gypsum and 10 wt % fiber, with Test 1 having 20% solids and Test 2 having 15.0% solids. The paper used in Test 1 was 222 grams/m² (20 grams/ft²) of cloquat and 222 grams/m² (20 grams/ft²) of research hydropulp paper in Test 2.

All four samples were subsequently pressed to form board samples. Density and MOR measurements were taken from 2 specimens of each of the samples, and the average of at least 3 measurements is reported in TABLE 1. Density was determined by dividing the measured weight by the measured volume, while MOR was determined according to ASTM D1037 test method. As the tables which follow will show, the current invention can produce a paper composite board with a paper surface layer that has a modulus of rupture (MOR) competitive with the gypsum fiberboard produced by the earlier described process of U.S. Pat. No. 5,320,677; but at lower density, and therefore lower weight. Moreover, it can be produced over a range of density and thickness and at lower cost.

TABLE 1

| Test | | Thickness | Density | MOR |
|---|---|---|---|---|
| Number | Sample | (in.) | (lb/ft³) | (lbs/in²) |
| Test 1 | Control | 0.487 | 54.01 | 874 |
| Test 1 | 3 layer | 0.499 | 48.60 | 852 |
| Test 2 | Control | 0.479 | 50.41 | 874 |
| Test 2 | 3 layer | 0.527 | 47.54 | 919 |

The data in TABLE 1 reflects that the MOR strength of the three layer composite boards at lower average density of 242.8 kg./m³ (48.1 lbs./ft³) was the same or higher compared to the control GWF composite board with a higher average density of 243.4 kg./m³ (52.2 lbs./ft³).

### EXAMPLE 2

The laboratory test procedures of Example 1 were repeated for composite materials of Test 2 and Test 3 set forth in TABLE 2. The composite materials were made in different runs with two layers, i.e., one paper layer as a top layer over the composite, and in one instance in Test 2 as a bottom layer under the composite. The composite-paper boards were made on a laboratory scale by forming a paper layer and dewatering the layer, depositing a gypsum wood fiber (GWF) slurry made by the process of U.S. Pat. No. 5,320,677 (used as the control) on the paper followed by dewatering and then depositing a face paper slurry on the GWF and dewatering pressing and drying. The composite was prepared using a slurry comprising 90 wt % gypsum and 10 wt % fiber, with Test 2 having 15.0% solids and Test 3 having 20.0% solids. The paper used in Test 2 was 222 g/m² (20 grams/ft²) of research hydropulp paper and 222 g/m² (20 grams/ft²) of cloquat in Test 3.

All four samples were subsequently pressed to form board samples. Density and MOR measurements were taken from 2 specimens of each of the samples, and the average of at least 3 measurements is reported in TABLE 2. Density was determined by dividing the measured weight by the measured volume, while MOR was determined according to ASTM D1037 test method.

As the tables which follow show, the current invention can produce a paper composite board with a paper surface layer that has a modulus of rupture (MOR) competitive with the gypsum fiberboard produced by the earlier described process of U.S. Pat. No. 5,320,677; but at lower density, and therefore lower weight. Moreover, it can be produced over a range of density and thickness and at lower cost.

TABLE 2

| | | | | MOR (lb/in²) |
|---|---|---|---|---|
| | Thickness | Density | MOR | Adjusted for Density |
| Sample | (inches) | (lb/ft³) | (lb/in²) | of control |
| Test 2 Control | 0.479 | 50.41 | 874 | 874 |
| Test 2, 2 layer | 0.495 | 42.93 | 581 | 801 |
| Test 2, 2 layer | 0.488 | 39.40 | 765 | 1252 |
| (tested with | | | | |
| paper down) | | | | |
| Test 3 Control | 0.522 | 39.68 | 464 | 464 |
| Test 3, 2 layer | 0.526 | 41.32 | 419 | 386 |

Although the results of Test 2 did not produce an absolute improvement in MOR over the Test 2 control, the 2 layer, and in particular the two layer where the paper side is down, does produce a higher MOR value at a significantly reduced density. This is shown in the last column when the MOR of the test samples are adjusted to the density of the Test Control sample by multiplying the MOR of the Test Control sample by the ratio of the square of the Density of the Control divided by the square of the density of the test sample. The MOR for the samples of Test 3 are not significantly different for samples that had very similar densities.

The test sample of the two layer tests produced a gypsum cellulose composite board with finished appearance of a conventional paper face gypsum board and is more abuse resistant than standard gypsum composite board.

### EXAMPLE 3

A comparison of the use of lamination of a standard wallboard paper on a ½ inch thick co-calcined composite board surface using a standard commercially available adhesive was performed using standard USG Corporation wallboard (Manila) paper having a thickness of between 11-13 mm. The adhesive was Elmer's Glue-All® brand of polyvinyl acetate adhesive manufactured by Elmer's Products, Inc. of Columbus, Ohio 43215 and was used in a standard level of usage of 5 grams/square ft.

The following five samples were prepared:

Control 1 of a standard composite board prepared by the process of U.S. Pat. No. 5,320,677.

Control 2 of the same board of Control 1 with 5.0 grams of adhesive being applied on the board surface and dried. Control 2 is provided to measure the effect of the adhesive on any strength enhancement of the board due to the laminating adhesive.

Sample 3 was the standard gypsum wood fiber (GWF) board with 5.0 grams of adhesive/square foot applied to one surface and then wallboard paper laminated on the adhesive surface.

Sample 4 had an adhesive applied to one surface and then paper was applied to the adhesive surface and then the same amount of adhesive was applied on the back surface Sample 4 was tested with the paper layer down, i.e. the paper layer under strain.

Sample 5 had paper laminated on both sides.

All of the control and experimental samples were tested according to ASTM D-1037 method to determine the effect of paper lamination on the board surface for density and strength. The results are shown in TABLE 3.

TABLE 3

| | Thickness | Density | MOR | Weight |
|---|---|---|---|---|
| Sample | (inches) | (lb/ft³) | (lb/in²) | (Lb/Mft²) |
| 1 - Control | 0.505 | 61.2 | 1017 | 2573 |
| 2 - Control w/adhesive | 0.505 | 63.2 | 1077 | 2659 |
| 3 - Paper - 1 side face up | 0.517 | 62.9 | 1074 | 2705 |
| 4 - 3 Paper - 1 side face down | 0.516 | 63.1 | 1681 | 2711 |
| 5 - Paper - 2 sides | 0.533 | 61.9 | 1594 | 2745 |

The above test results indicate the effect of paper on improving the strength of the board at particular densities for samples made with layers attached by adhesive. However, the three layer composite boards of this invention will typically be manufactured without use of laminating adhesive as described above in relation to the continuous method of preparing fiber layers from paper slurries on the web.

The use of the lower temperature paper slurry on the top layer over the co-calcined composite board has the desirable effect of lowering the temperature of the board mat prior to pressing and thereby accelerating the rate of hydration of the composite with corresponding improvement in processing efficiency and lower cost.

As can be seen from the above results, the use of adhesive had no significant effect on the board strength when compared to the Control 1. The slight increase in the MOR of the adhesive treated board is due to the higher density of the board compared to the untreated composite board control.

The significant increase in the MOR strength of the one side paper laminated board when the paper surface was under strain during the testing (more than 600 lb/in² or 55%), indicates that the paper on the back of the board surface develops an abuse resistant composite board.

The noted slightly decreased MOR strength of the board that is laminated with paper on both sides compared to lamination on one side is attributable to the lower density of the one side paper laminate.

Certain general observations can be drawn from the data in TABLE 3 Of particular note, by comparing density and MOR, the new paper fiber and composite gypsum/wood-fiber board can provide a MOR in the range acceptable to the construction industry at lower densities than the competitive gypsum fiberboards.

Although the invention has been discussed in connection with particular illustrative embodiments, other embodiments, modifications, variations, and improvements in the composite material and method for making it, as well as other beneficial uses of the resulting material, will undoubtedly occur to those skilled in the art once they have become familiar with the invention as hereafter claimed.

We claim:

1. A method comprising:
preparing a first slurry comprising a mixture of cellulosic fiber and water,
depositing said first slurry on a web where it is dried to form a fiber layer,
mixing a second slurry comprising a mixture of gypsum and cellulosic fiber in an autoclave under temperature and pressure sufficient to co-calcine the gypsum and cellulose fiber in said second slurry,
depositing the calcined gypsum and cellulosic fiber second slurry on the fiber layer to form a gypsum and cellulosic fiber composite layer on the fiber layer,
pressing the gypsum and cellulosic fiber composite layer and fiber layer to form a composite mat having a cellulosic fiber layer and a gypsum cellulosic fiber layer,
rehydrating the gypsum cellulosic fiber layer of the composite mat, and drying the rehydrated composite mat.

2. The method of claim 1, wherein the cellulosic fiber first slurry contains about 2 to about 5% by weight cellulose fiber.

3. The method of claim 1, wherein a second paper fiber layer is deposited on a top surface of the composite mat prior to rehydrating the composite mat.

4. The method of claim 1, wherein a second paper fiber layer is deposited on a top surface of the composite mat prior to pressing the composite mat.

5. The method of claim 2, wherein the top layer of fiber is coated on the gypsum cellulose fiber composite.

6. The method of claim 1, wherein the rate of rehydration of the co-calcined gypsum and cellulose layer is accelerated by the deposit of the fiber slurry which is at a lower temperature than the co-calcined gypsum cellulose fiber slurry layer.

7. A co-calcined gypsum cellulose fiber composite board comprising a cellulosic fiber layer on at least one of the opposed surfaces of a co-calcined gypsum cellulose fiber composite.

8. The board of claim 7, wherein the cellulosic fiber layer is a paper layer having a thickness of about 9 to 15 mm.

9. The board of claim 8, wherein the thickness of the paper layer is about 9 to about 11 mm.

10. The board of claim 7, wherein there is a cellulosic fiber layer on both opposed surfaces of the composite.

11. The board of claim 7, wherein the modulus of rupture of the board is substantially equal to or greater than the modulus of rupture of a composite board having the same density which does not have at least one cellulosic fiber layer on its surface.

12. The board of claim 7, wherein the cellulosic fiber layer is a paper layer laminated to the surface of the composite board.

13. A method comprising:
preparing a slurry comprising gypsum, cellulose fiber and water,
heating the slurry in an autoclave under sufficient pressure and a temperature above 200° C. to calcine the gypsum crystals and the wood fiber slurry,
depositing the slurry under pressure and at a temperature above about 93° C. on a web to form a layer of slurry,
pressing the layer of slurry to remove water and form a gypsum cellulose fiber composite mat,
rehydrating the gypsum cellulose fiber composite mat to cure the gypsum cellulose fiber composite mat,
drying the composite mat to form a gypsum cellulose fiber composite panel,
laminating a layer of wallboard paper to at least one surface of the composite panel, and
cutting and trimming the paper laminated composite panel.

14. The method of claim 13, wherein respective paper layers are respectively laminated on both surfaces of the gypsum cellulose fiber composite panel.
